(19) United States
(12) Patent Application Publication
(10) Pub. No.: US 2024/0208156 A1
(43) Pub. Date: Jun. 27, 2024

(54) FLUID DISPENSER CONTAINER AND METHOD FOR PRODUCING A FLUID DISPENSER CONTAINER

(71) Applicant: Ecospenser Technologies BV, Melle (BE)

(72) Inventors: Victor Gerrit VAN DOORN, Dongen (NL); Jeroen Herman MARSKAMP, Tilburg (NL); Mervin Gerard CLEIJ, Rotterdam (NL); Phil REGAN, Zaltbommel (NL)

(21) Appl. No.: 18/576,632

(22) PCT Filed: Jul. 5, 2022
(86) PCT No.: PCT/EP2022/068646

§ 371 Date: Jan. 4, 2024

(30) Foreign Application Priority Data
Jul. 6, 2021 (EP) 21184077.2

(51) Int. Cl. B29C 65/16; B29C 49/06; B29C 49/08; B29K 67/00; B29L 31/00; B65D 83/38; B65D 83/64

(52) U.S. Cl. CPC B29C 65/1616; B29C 49/06; B29C 49/08; B29C 65/1658; B29C 65/167; B65D 83/38; B65D 83/64; B29K 2067/003; B29L 2031/7142; B29L 2031/716

(57) ABSTRACT

A new fluid dispenser container is described which comprises a transparent plastic container body (12) with an open end and a separate bottom part (13) joined by laser welding to the open end of the transparent plastic container body. The separate bottom part (13) is made from the same transparent plastic material as the plastic container body (12) and the separate bottom part is laser welded to the plastic container body by melting mating surface lines on the plastic container body (12) and on the separate bottom part (13), whereas the heat to melt is created by a stationary laser means while the plastic container body has been rotated by rotating means at least over a full rotation or by a circularly movable laser means in a full circular motion while the plastic container is stationary.

The invention is related to a fluid dispenser container comprising a transparent plastic container body and a bottom part joined by laser welding to the transparent plastic container body according to the preamble of claim 1, and a method for producing a fluid dispenser container according to the preamble of claim 16.

### FIELD OF THE INVENTION

A fluid dispenser container with a plastic container body with a dispensing valve and a separate bottom part mounted to the plastic container body is known as plastic aerosol and produced by the applicant and sold to the market since several years. However, the main problem of known fluid dispensers of this type is that they are made of different resins or different resin families, i.e. the container body may be produced from PET, whereas the dispensing valve is made of sheet metal and the bottom part is made of engineering plastics, reinforced with glass fibres, filled with additives like carbon black and containing a rubber plug to close the package after pressurizing the container with a gas as an aerosol, air or the like.

### BACKGROUND OF THE INVENTION

EP 1 791 769 B1 describes an aerosol container for dispensing a pressurized product, which includes a body, stretch blow moulded from PET or like plastics material, said body having a shaped neck surrounding an opening, a collar, injection moulded from plastics material, snap-fitted to the shaped neck, and a dispensing valve attached to said neck and collar. The dispensing valve includes an outer flange with is formed of malleable material (e.g. aluminium) and which is shaped to fit about and be retained to said collar by being compressed therearound. The body 2 of the container includes a base or bottom part 6 and a neck portion 7, which are all integrally formed by stretch blow moulding PET from a preform. The collar 3 as a separate part is formed from plastics material by injection moulding and has on the inner surface an annular lip which can be snap fitted to an annular recess 9 of the shaped neck 7. The dispensing valve 4 is of a conventional type which is formed of metal malleable material (i.e. aluminium). The outer flange 11 is shaped to fit to the collar 3.

EP 1 943 165 B1 concerns an aerosol container for dispensing a pressurized product, including a body 2, formed of PET or like plastics material, which body has a shaped neck 7 about an opening 10, a collar 3 which straddles the external and internal walls 33, 34 of the opening 10 to form a shaped lip 35 therearound and be attached to the body 2. The container further includes a dispensing valve attached to the collar 3, wherein the valve including an outer flange 11 formed of metal or malleable material (e.g. aluminium) and be retained thereto by compressing therearound.

WO 2017/112977 A9 describes a pressurized container system which comprises a container 1 provided by a cylindrical casing 22 with a neck part 23 with a pouring opening 24. The bottom side of the casing 22 is cut away and closed by a separate base part 21 by means of a connection 13. The container 1 is made of a plastic material which is biaxially stretchable and has a high intrinsic viscosity, which is characterized by a high pressure resistance. Especially, a heat set blow-moulding process is applied to obtain an accelerated crystallisation effect of the plastic material, i.e. hot-fill PET. Other materials as PET copolyesters with a high pressure resistance are mentioned. The container may also be made of polyamide, polysty-rene and COC. A base part 21 is attached to the container 1 by a joint, which may 25 be obtained by gluing, folding or welding, in particular laser welding induction welding or ultrasonic welding. Any further information about the kind of joint and how the joint is exactly made, is not described. In order to pressurize the container a closable valve is provided in said base part, which is of a so-called “umbrella plug” or a so-called two-stage “Nicholson plug”. These plugs are normally made from rubber.

Since environmental sustainability is becoming much more important, the compo-nents of such a fluid dispenser container should be made of similar material so that used containers can easily be recycled. Especially the materials used must be com-patible with established and commonly used in plastics recycling streams.

As an example WO 2015/061071 A1 describes an aerosol dispenser made from materials which can go into a single recycling stream having a single class of materials, defined by the Society of the Plastics Industry (USA), and particularly comprises exclusively Class 1 materials (PET) with no flammable product/propellant present. The production process of above mentioned aerosol dispenser is not described. Moreover, the base is integrally formed with the outer container, as is obvious from FIGS. 2A and 2B.

The present invention, however, is specifically directed to a fluid dispenser container with a plastic container body with a dispensing valve and a separate bottom part mounted to the plastic container body.

Since the above mentioned pressurized container systems should withstand higher pressures, e.g. up to 20 bar, which have to fulfil regulatory and legal requirements e.g. DOT-, FEA and BS-Standards for plastic aerosols, it is very important that there is a secure and pressure-safe seal connection between the bottom part and the lower open-end of the container. The applicant has a large experience in producing plastic aerosols, i.e. high pressure containers since more as a decade and has made intensive experiences in connecting a separate bottom part to the a high-pressure container by laser welding. For a secure laser welding joint between the separate bottom part and the high-pressure container, which is made of transparent PET, the plastic material of the bottom part, which is e.g. glass fibre reinforced engineering plastic and is different from PET, is mixed with carbon black in order to absorb the laser light and to obtain a pressure-safe and break-proof weld between the bottom part and the pressure container. In some instances there are provided two parallel ring-shaped laser welds between the bottom part and the pressure container. Currently, the bottom part is made from glass fibre reinforced PBT (poly-butylenterephthalat) and 1% carbon black. The glass fibres are added to stop creep—under constant overpressure plastic tends to keep on stretching which would finally result in a balloon-shaped high-pressure container. The PBT used is impact modified, which means that it can absorb the impact as required in the regulatory drop test. Another aspect is the chemical resistance. Previously, polycarbonate (PC) was used, which is highly sensitive for many chemicals used in customer products. Besides this fact, PBT has much better gas barrier properties, which is essential for maintaining the pressurized gas.

At present there is no available method for laser welding a circular tube as the above-mentioned pressure container and a transparent bottom part, which is good enough to withstand the high forces and guarantees a high seal integrity.

It is an object of the present invention to provide a fluid dispenser container with a plastic container body with a dispensing valve and a separate bottom part, which are all made from the same plastic material, especially PET or PEN, and which fluid dispenser container can withstand elevated pressures under extreme performance requirements as drop test from 1.8 m at 18° C., etc. A further object of the invention is to provide a method of laser welding a transparent bottom part to a transparent plastic container body, in order to obtain a secure joint between the transparent bottom part and the transparent container body which creates sufficient strength to withstand impact and creep load.

This object is achieved by a fluid dispenser container with the features of claim 1 and by the method for producing such a fluid dispenser container with the features of claim 16.

In accordance with an aspect of the present invention the fluid dispenser container comprises a transparent plastic container body with an open end and a separate bottom part joined by laser welding to the open end of the transparent plastic container body, wherein the separate bottom part is made from the same transparent plastic material as the plastic container body and the separate bottom part is laser welded to the plastic container body by melting mating surface lines on the plastic container body and on the separate bottom part, whereas the heat to melt is created by a stationary laser means while the plastic container body has been rotated by rotating means at least over a full rotation or by a circularly movable laser means in at least a full circular motion while the plastic container is stationary.

In an advantageous embodiment according to claim 2 the plastic material of the transparent container body and of the transparent bottom part is PET, PEN or other plastic material from the polyester family thereof.

In a further advantageous embodiment according to claim 3 a piston for dispensing fluid is provided, which is made from a plastic material with a density lower as the density of PET.

In a further advantageous embodiment according to claim 4 the transparent bottom part has a ring-shaped outer rim and an inner cup which has a central passageway provided by a central cylindrical tube with an upper central hole.

In a further advantageous embodiment according to claim 5 the outer rim, the inner cup and the central tube have the same material thickness.

In a further advantageous embodiment according to claim 6 radial ribs between the central tube and an outer wall of the inner cup are provided, in order to strengthen the central tube against the outer rim.

In a further advantageous embodiment according to claim 7 lower supporting ribs between the outer rim and the inner cup are provided which are protruding obliquely from the inner wall of the outer rim to the lower part of the inner cup in order to provide large stability, reducing deformation from the outer wall under extreme conditions and a perfect circular cylindrical form with high precision of the transparent bottom part.

In a further advantageous embodiment according to claim 8 the transparent bottom part comprises an outer ring-shaped rim with a bottom part, radial ribs and a central passageway provided by a central tube with an upper central hole.

In a further advantageous embodiment according to claim 9 the upper central hole is bridged or domed by a cylindrical plug which is connected to opposite pillars protruding from the central tube.

In a further advantageous embodiment according to claim 10 a fill valve a closing element is mounted in the central tube which has a cuplike base part with an inner blind hole and a ring-cylindrical protruding rim, whereas on top of the base part an upper frusto-conical section with two opposing grooves is provided.

In a further advantageous embodiment according to claim 11 the closing element is made from PET, PEN or other plastic material from the polyester family thereof.

In a further advantageous embodiment according to claim 12 the central cylindrical tube has open ends on both ends and a movable closing element of an elastomeric material is provided within the central tube.

In a further advantageous embodiment according to claim 13 the closing element is designed as two stage Nicholson plug or as umbrella valve or as rope bung plug.

In a further advantageous embodiment according to claim 14 a pressure control device with a transparent high pressure container is mounted in the lower part of the plastic container body.

In a further advantageous embodiment according to claim a disc with a pressure control device made of a transparent material is welded to the inner wall of the transparent container to provide a high pressure chamber between the disc and the bottom part.

According to claim 16 the method for producing a fluid dispenser container is provided, wherein the transparent container body is made by injection stretch blow moulding from a preform and the bottom of the container body is cut-off to provide an open lower end of the container body, further the separate transparent bottom part is made by injection moulding in which molten plastic material is shaped in the desired form by multiple cavity moulds, and the separate bottom part is laser welded to the plastic container body by melting mating surface lines on the plastic container body and on the separate bottom part, whereas the heat to melt is created by a stationary laser means while the plastic container body has been rotated by rotating means at least over a full rotation or by a circularly movable laser means in at least full circular motion while the plastic container is stationary.

According to claim 17 it is advantageous, when a thin ring-shaped absorber layer is applied to the outer wall of the transparent bottom part and then joined by laser welding to the transparent container.

According to claim 18 it is advantageous, when the thin-lined absorber layer is applied by using inkjet technology.

According to claim 19 it is advantageous, when the melting heat is created by a laser equipment selected by the group diode, YAG or fiber lasers which typically work with an absorber coating on one of the two parts to be joined.

According to claim 20 it is advantageous, when transparent laser plastic welding (TLPW) is applied, in which a higher wavelength laser is used than the typical 808 nm or 980 nm infrared lasers used in through-transmission welding, such that some of the laser energy is still transmitted or passed through the transparent container body, but at this higher wavelength laser energy is absorbed through the separate transparent bottom part, in order to heat and plasticize the plastic material at the joint area between the transparent container body and the separate transparent bottom part.

According to claim 21 it is advantageous, when the laser means is sending a laser beam having a wavelength of 1900 to 2100 nm, preferably 2000 nm, which welds the transparent container body and the separate transparent bottom part without the use of absorber layers, whereas the melting heat is generated in the focus of the laser beam.

Further advantages can be derived from the description below.

### BRIEF DESCRIPTION OF THE DRAWING FIGURES

The invention will now be described in greater detail, by way of example, with reference to the accompanying drawings, in which:

FIG. 1 shows a fluid dispenser container of the state of the art,

FIG. 2 shows a fluid dispenser container according to the present invention,

FIG. 3 shows the same fluid dispensing container in upright position,

FIG. 4 shows the fluid dispensing container with a pressure control device,

FIGS. 5 to 7 show a first embodiment of a transparent bottom part,

FIGS. 8 and 9 show a fill valve inserted in the transparent bottom part,

FIGS. 10 and 11 show the two positions of the fill valve,

FIGS. 12 and 13 show a second embodiment of the transparent bottom part,

FIG. 14 shows a disc with a pressure control device, and

FIGS. 15 and 16 show the disc and the pressure control device integrated in the plastic dispensing container.

### DETAILED DESCRIPTION OF THE PREFERRED EMBODIMENTS

In the figures the same reference numbers are used for the same elements, if not mentioned otherwise.

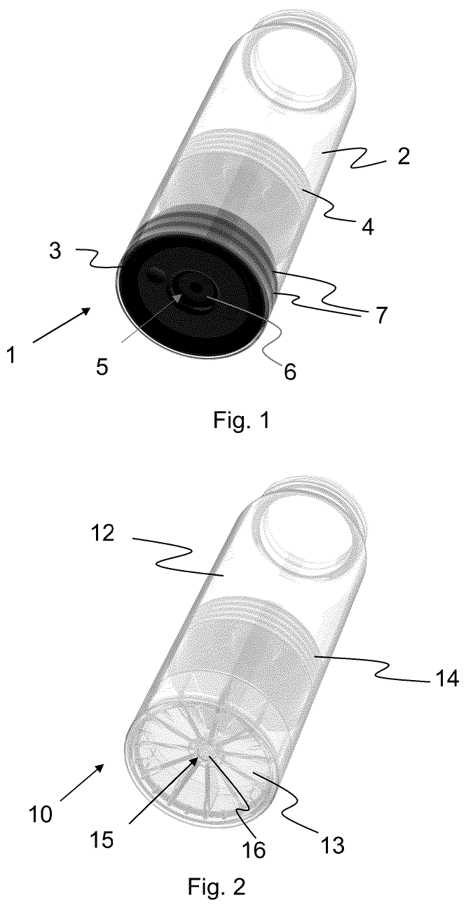

FIG. 1 shows a fluid dispenser container 1, as produced by the applicant since more than a decade and thus is state of the art, with a transparent plastic container 2 made of PET, a black bottom part 3 made of PBT mixed with carbon black and a piston 4 made of a resilient plastic material. Further the bottom part 3 has a central hole 5, in which a rubber fill valve 6 or Nicholson plug is inserted. As can be seen the bottom part 3 is joined to the plastic container 2 by two welding rings 7, which are provided by a stationary laser means with a wavelength of 1.9 nm, whereas the plastic container 2 is rotated by rotating means as e.g. rollers or the like.

In FIG. 2 a fluid dispenser container 10 according to the present invention is shown, in which the bottom end of a transparent plastic container 12 is cut-off and a transparent bottom part 13 is joined by laser welding to the plastic container 2. The transparent bottom part 13 has a special construction which will be explained in more details below. The transparent bottom part 13 and the transparent container 12 are made from the same plastic material, preferably from PET, PEN or other plastic material from the polyester family thereof. A piston 14 is movable within the transparent plastic container 12. The piston 14 is made of a plastic material having a density lower as the density of PET, preferably a density <1. The piston 14 may thus be made of PE (e.g. LDPE or HDPE) or PP, as it can be separated in the recycling stream by floating density. Instead of piston 14 a dip-tube or a plastic bag can be used, which are also made from a low-density plastic material, in order to recycle the PET part of the fluid dispenser container 10 to recycled PET (rPET) according to the standards of the Waste Framework Directive of the European Com-mission and Directive (EU) 2019/904 of the European Parliament and of the Council of 5 Jun. 2019 on the reduction of the impact of certain plastic products on the environment. See e.g. https://ec.europa.eu/environment/topics/waste-and-recy-cling/waste-framework-directive_en). The technical standards for the plastics recy-cling industry are outlined in the APR Design Guide for Plastics Recyclability (see www.PlasticsReycling.org) and in the PET Recycling Test Protocol of the European PET Bottle Platform of September 2017.

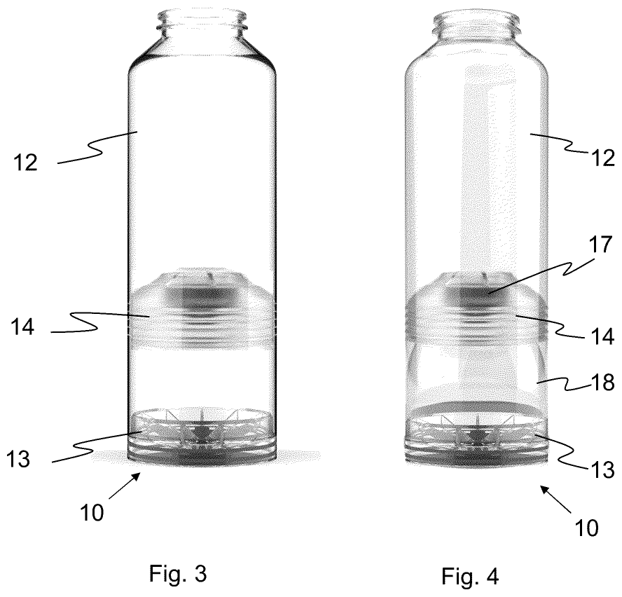

In FIG. 3 the fluid dispenser container 10 according to the invention is shown in upright perspective view in which solely a movable piston 14 is provided, and in FIG. 4 the same fluid dispenser container 10 is shown, whereas a pressure control device 17 with a transparent high pressure container 18 of PET, PEN or other plastic material from the polyester family thereof and the movable piston 14 is shown. On the top of the container 10 a dispensing valve and push button or valve actuator (not shown) of plastic material is placed and sealed to the container for dispensing of the contents. Preferably, this top valve is made from the same plastic material as the transparent plastic container 12 and thus does not contain metal, rubber or any completely different plastic material. In the present application the top valve is connected to the transparent plastic container 12 by spin welding. However, also other welding methods as laser welding, ultrasonic welding or vibration welding can be used.

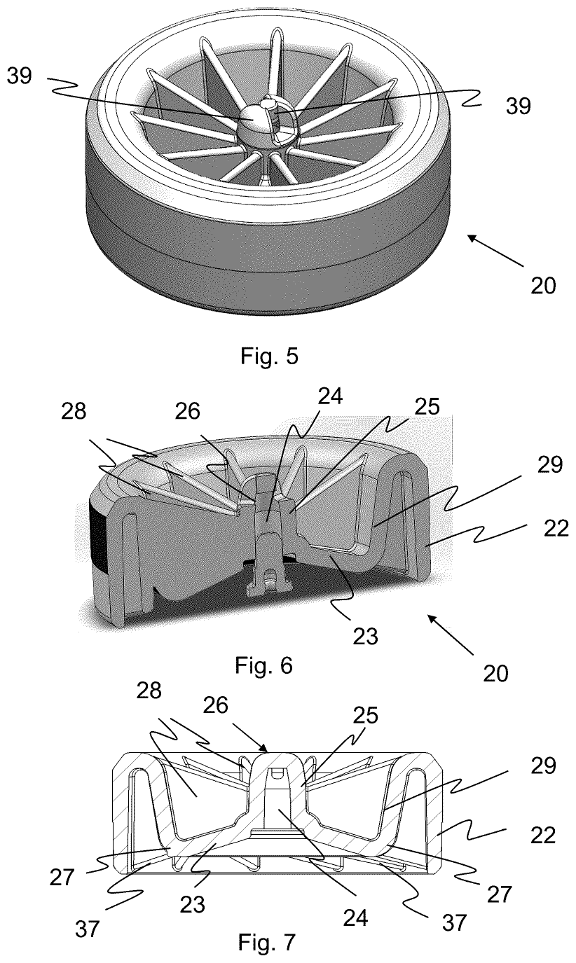

FIG. 5 shows a first preferred embodiment 20 of the transparent bottom part 13 in an upper perspective view. The design of this transparent bottom part 20 has been developed by Finite Elements Method (FEM) wherein the strength and mechanical forces are optimized in order to reduce the tensile strength, preferably lower than the yield point (avoiding permanent deformation under normal temperature conditions). As can be seen in FIGS. 6 and 7 the main part of the bottom part 20 is provided by a ring-shaped outer rim 22, which creates a welding surface, and an inner cup 23 which has a central passageway 24 provided by a central cylindrical tube 25 with an upper central hole 26. As can be seen in FIGS. 6 and 7 the outer rim 22, the inner cup 23 and the central tube 25 have the same material thickness, i.e. the material thickness is within a difference of 0.1 mm the same. In order to strengthen the central tube 25 against the outer rim 22 there are provided radial ribs 28 between the central tube 25 and the outer wall 29 of the inner cup 23. The transparent bottom part 13 is an injection moulded part with a special rib design in order to create the highest possible strength with lowest possible resin consumption.

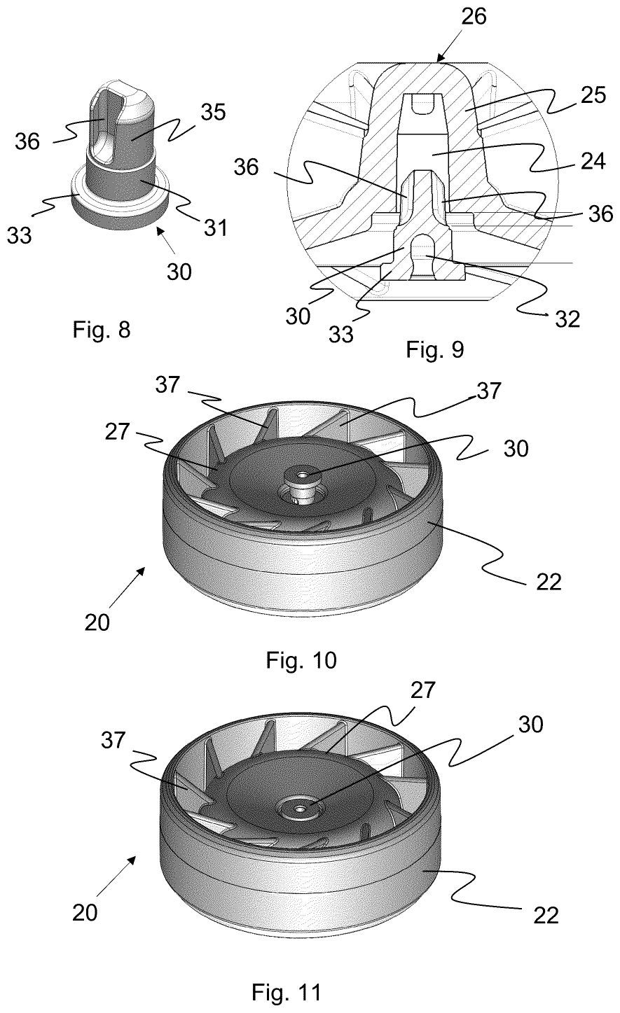

In the passageway 24 a fill valve 30 is provided which is shown in more details in FIGS. 8 and 9. As can be seen in FIG. 8 the fill valve 30 has a cuplike base part 31 with an inner blind hole 32 and a ring-cylindrical protruding rim 33. On top of the base part 31 an upper frusto-conical section 35 with two opposing grooves 36 is provided. In a first position as shown in FIG. 9 the fill valve 30 is pinched in the central passageway 24 such that a gas or air can pass from outside through the central hole 26 into the container 10 under the piston 14 (see FIGS. 3 and 4). This first position of the fill valve 30 is depicted in FIG. 10, whereas in FIG. 11 a second position of the fill valve 30 is shown, wherein the passageway 24 is closed. In the first position the fill valve 30 is fixed by pretension between the base part 31 and the central tube 25. In the second position a higher pretension comes into action which normally would not allow to push the fill valve 30 into the end position in which the passageway 24 is completely closed. However, the fill valve 30 in the second position is hermetically sealed to the central tube 25 by ultrasonic welding, which brings thermal energy in this area, so that the fill valve 30 can be pushed into its end position and the protruding rim 33 is melted to the lower end of the central tube 25 by providing a shear joint.

As further can be seen in FIGS. 10 and 11 between the outer rim 22 and the inner cup 23 there are provided lower supporting ribs 37 which are protruding obliquely from the inner wall of the outer rim 22 to the lower part 27 of the inner cup 23 (see also FIG. 7). The inner radial ribs 28 and the lower supporting ribs 37 give the transparent bottom part 20 large stability and perfect circular cylindrical form with high precision. In addition the upper central hole 26 is bridged or domed by a cylindrical plug 38 which is connected to opposite pillars 39 protruding from the central tube 25 (see FIG. 5). The transparent bottom part 20 is produced by injection moulding in which molten plastic material is shaped in the desired form by multiple cavity moulds. In the injection moulding process it is very important to inject the molten plastic material at a central position so that the molten plastic material can spread out equally in all directions, providing a homogenous product without any inclusions or sinks. If the molten plastic material is injected at an eccentric point stress areas are induced by flow-lines which may cause cracks under extreme impact conditions. Thus, the cylindrical plug 38 is originated from the injection of the molten plastic material at the central point of the transparent bottom part 22.

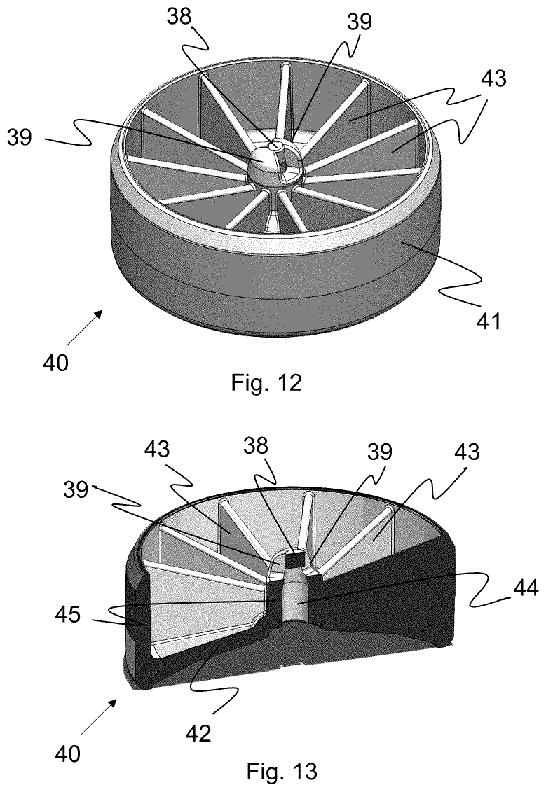

In FIGS. 12 and 13 a second preferred embodiment 40 of the transparent bottom part 13 is depicted, which is also designed by FEM. The bottom part 40 of this design has an outer ring-shaped rim 41 with a bottom part 42 and radial ribs 43. Also here a central passageway 44 is provided by a central tube 45 with an upper central hole 46. A similar fill valve 30 as in FIGS. 8 and 9 will be inserted into the central tube 45 and welded thereto by ultrasonic welding to hermetically seal the passageway 44. In this second embodiment 40 the central passageway or hole 44 is also bridged or domed by a cylindrical plug 38 which is connected to opposite pillars 39 protruding from the central tube 45.

In order to join the transparent bottom part 13 and the transparent plastic container 12 the stationary laser for the production of the known fluid dispenser container 1 of FIG. 1 cannot be used. Welding clear polymers require special infrared absorbers which are expensive and difficult to apply.

The diameter of the transparent bottom part 13 is slightly larger than the iinner diameter of the open lower end of the transparent container 12, so that the transparent bottom part 13 is press-fit into the transparent container 12 before it is welded.

The transparent bottom part 13 and the transparent container 12 are made from the same plastic material, preferably from PET, PEN or other plastic material from the polyester family thereof, and are joined by mating surface lines, whereas the melting heat is created by a laser equipment, which can be diode, YAG or fiber lasers which typically work with an absorber coating on one of the two parts to be joined. These lasers have a wavelength between 0.8 and 1.1 μm. A thin ring-shaped absorber layer is applied to the outer wall of the transparent bottom part 13 and then joined by laser welding to the transparent container 12. The thin-lined absorber layer is preferably applied by using inkjet technology which gives a good control and relia-bility on the distribution of the printed volume. Full opaque lines or dot printing can additionally be used. The objective for the recycling process is to use a minimum quantity of printing ink with carbon black. After laser welding the thin-lined absorber layer may partly disappear or fade away, so that a clear joint between the transparent container 12 and the transparent bottom part 13 is obtained.

Another possibility is using transparent laser plastic welding (TLPW) in which a higher wavelength laser is used, which interacts differently with the plastic than the typical 808 nm or 980 nm infrared lasers used in through-transmission welding. Some of the laser energy is still transmitted or passed through a clear thermoplastic, but at this higher wavelength some absorption is seen, volumetrically, through the part—enough volumetric absorption to heat and plasticize the polymer.

When lasers pass through any lens (or any transmitting medium, plastics in this case) some of that laser energy will be absorbed at the surfaces of the lens. In the case of transparent plastic welding there are four surfaces where absorption will increase: the upper surface, the two surfaces at the joint interface and the lower surface. Because the interface of the joint is comprised of two surfaces the majority of the absorption in clear-to-clear welding takes place here making it a perfect solu-tion for joining clear thermoplastics without absorber additives. The advantage thereof is that there are no additives or chemicals that may contaminate the recycled resin.

In a large series of experiments applicant experienced that a laser means with a laser beam having a wavelength between 1900 and 2100 nm, preferably 2000 nm, can be used to laser weld pieces of transparent PET without the use of absorber layers. In a large series of stability tests, i.e. drop tests from 1.8 meters at a temperature of −18° C. during 24 hours, it could be proved that the laser weld joints between the separate transparent bottom part 13 and the transparent plastic container 12 have been break-proof. The melting heat is generated in the focus of the laser beam.

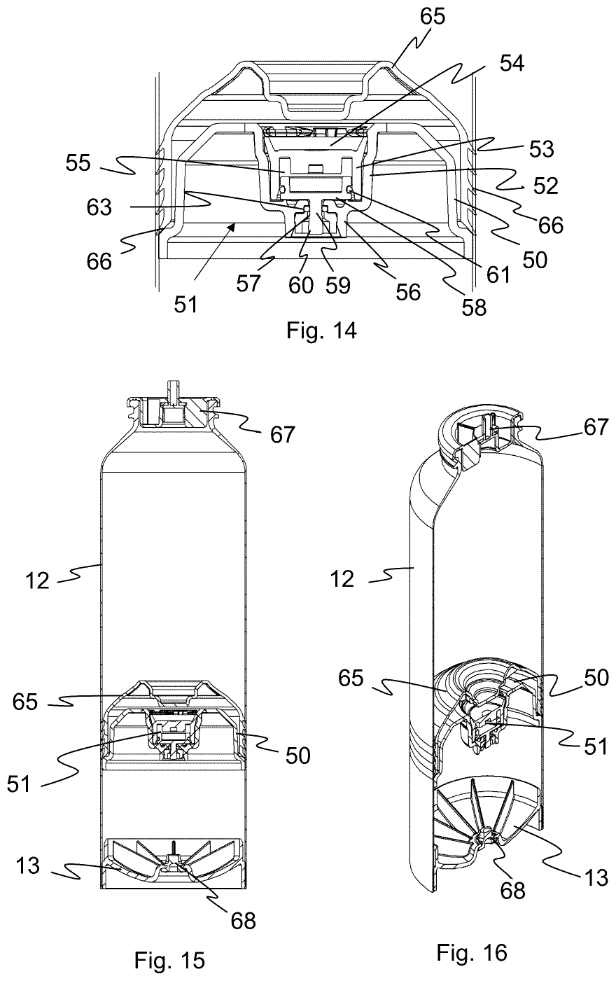

Instead of the pressure control device 17 with the transparent high pressure container 18 as has been depicted in FIG. 4, a disc 50 with a pressure control device 51 can be provided as shown in FIG. 14. The disc 50 is preferably dome shaped and made of the same transparent material, i.e. PET, PEN or other plastic material from the polyester family thereof. The pressure control device 51 comprises a cup-like closure 52, in which a cylindrical member 53 with a closed upper end 54 is mounted, such that a reference pressure chamber 55 is provided. The bottom part 56 of the cuplike closure 52 has a valve opening 57. In the reference pressure chamber 55 a piston 58 with a downward protruding stem 59 and a cylindrical end stop 60 is adapted. Outside the piston 58 an O-ring 61 is provided for sealing the piston 55 towards the inner wall of the cylindrical member 53. In the downside end of the valve opening 57 an O-ring 63 is provided which cooperates with the end stop 60. The working of the pressure control device 51 is described in more details in WO-A-2005/082744. Any other type of pressure control device may be used instead of the pressure control device 51.

Above the dome shaped disc 50 with the pressure control device 51 a dome shaped piston 65 with scraping fins 66 is provided for separating the dispensing fluid (not shown) from the pressurized air underneath the piston 65.

FIGS. 15 and 16 show the transparent plastic container 12 with the transparent bottom part 13, the dome shaped disc 50 with the pressure control device 51 and the dome shaped separating piston 65. Disc 50 is connected to the inner wall of plastic container 12 in the lower region thereof, in order to provide a high pressure chamber between the disc 50 and the bottom part 13 of the container 12. On top of the container 12 a plastic valve 67 is mounted. Such a plastic valve 67 is known e.g. from WO 2018/133925 A1.

The preferably dome shaped disc 50 is laser welded to the inner wall of the plastic container 12 in the same manner as described above, i. e. applying a thin ring-shaped absorber layer to the outer wall of the transparent disc 50 and then joining the mating surfaces by laser welding to the transparent container 12. Also the plastic valve 67 is laser welded to the top of the container 12 as described above with respect to the base part 13. However, different welding methods as spin welding, ultrasonic welding or vibration welding may be used.

The transparent bottom parts 20 and 40 may also have a central tube 25 or a central tube 45 which are open-ended on both ends, in which a closing element of an elastomeric material is provided. This closing element can be designed as two stage Nicholson plug 68 as can be seen in FIGS. 15 and 16. Also other elastomeric plugs as closing member for the high pressure chamber underneath the dome shaped separating piston 67 can be used. Such plugs are known as umbrella valve or rope bung plug.

1. A fluid dispenser container comprising a transparent plastic container body (12) with an open end and a separate bottom part (13) joined by laser welding to the open end of the transparent plastic container body, characterized in that the separate bottom part (13) is made from the same transparent plastic material as the plastic container body (12) and the separate bottom part is laser welded to the plastic container body by melting mating surface lines on the plastic container body (12) and on the separate bottom part (13), whereas the heat to melt is created by a stationary laser means while the plastic container body has been rotated by rotating means at least over a full rotation or by a circularly movable laser means in at least full circular motion while the plastic container is stationary.

2. A fluid dispenser container according to claim 1, characterized in that the plastic material of the transparent container body (12) and of the transparent bottom part (13) is PET, PEN or other plastic material from the polyester family thereof.

3. A fluid dispenser container according to claim 1 or 2, characterized in that a piston (14) for dispensing fluid is provided, which is made from a plastic material with a density lower as the density of PET.

4. A fluid dispenser container according to one of claims 1 to 3, characterized in that the transparent bottom part (13; 20) has a ring-shaped outer rim (22) and an inner cup (23) which has a central passageway (24) provided by a central cylindrical tube (25) with an upper central hole (26).

5. A fluid dispenser container according to claim 4, characterized in that the outer rim (22), the inner cup (23) and the central tube (25) have the same material thickness.

6. A fluid dispenser container according to claim 5, characterized in that radial ribs (28) between the central tube (25) and an outer wall (29) of the inner cup (23) are provided, in order to strengthen the central tube (25) against the outer rim (22).

7. A fluid dispenser container according to claim 6, characterized in that lower supporting ribs (37) between the outer rim (22) and the inner cup (23) are provided which are protruding obliquely from the inner wall of the outer rim (22) to the lower part (27) of the inner cup (23) in order to provide large stability, reducing deformation from the outer wall under extreme conditions and a perfect circular cylindrical form with high precision of the transparent bottom part (20).

8. A fluid dispenser container according to one of claims 1 to 3, characterized in that the transparent bottom part (13; 40) comprises an outer ring-shaped rim (41) with a bottom part (42), radial ribs (43) and a central passageway (44) provided by a central tube (45) with an upper central hole (46).

9. A fluid dispenser container according to claim 7 or 8, characterized in that the upper central hole (26; 46) is bridged or domed by a cylindrical plug (38) which is connected to opposite pillars (39) protruding from the central tube (25; 45).

10. A fluid dispenser container according to one of claims 4 to 9, characterized in that a fill valve (30) as closing element is mounted in the central tube (25; 45) which has a cuplike base part (31) with an inner blind hole (32) and a ring-cylindrical protruding rim (33), whereas on top of the base part (31) an upper frusto-conical section (35) with two opposing grooves (36) is provided.

11. A fluid dispenser container according to one of claim 10, characterized in that the closing element is made from PET, PEN or other plastic material from the polyester family thereof.

12. A fluid dispenser container according to claim 4, characterized in that the central cylindrical tube (25) has open ends on both ends and a movable closing element of an elastomeric material is provided within the central tube (25).

13. A fluid dispenser container according to claim 12, characterized in that the closing element is designed as two stage Nicholson plug or as umbrella valve or as rope bung plug.

14. A fluid dispenser container according to one of claims 1 to 13, characterized in that a pressure control device (17) with a transparent high pressure container (18) is mounted in the lower part of the plastic container body (12).

15. A fluid dispenser container according to one of claims 1 to 13, characterized in that a disc (50) with a pressure control device (51) made of a transparent material is welded to the inner wall of the transparent container (12) to provide a high pressure chamber between the disc (50) and the bottom part (13).

16. Method for producing a fluid dispenser container according to one of claims 1 to 15, wherein the transparent container body (12) is made by injection stretch blow moulding from a preform and the bottom of the container body is cut-off to provide an open lower end of the container body, further the separate transparent bottom part (13) is made by injection moulding in which molten plastic material is shaped in the desired form by multiple cavity moulds, and the separate bottom part (13) is laser welded to the plastic container body (12) by melting mating surface lines on the plastic container body and on the separate bottom part, whereas the heat to melt is created by a stationary laser means while the plastic container body has been rotated by rotating means at least over a full rotation or by a circularly movable laser means in a full circular motion while the plastic container is stationary.

17. Method according to claim 16, wherein a thin ring-shaped absorber layer is applied to the outer wall of the transparent bottom part (13) and then joined by laser welding to the transparent container (12).

18. Method according to claim 17, wherein the thin-lined absorber layer is applied by using inkjet technology.

19. Method according to claim 17 or 18, wherein the melting heat is created by a laser equipment selected by the group diode, YAG or fiber lasers which typically work with an absorber coating on one of the two parts to be joined.

20. Method according to claim 16, wherein transparent laser plastic welding (TLPW) is applied, in which a higher wavelength laser is used than the typical 808 nm or 980 nm infrared lasers used in through-transmission welding, such that some of the laser energy is still transmitted or passed through the transparent container body, but at this higher wavelength laser energy is absorbed through the separate transparent bottom part, in order to heat and plasticize the plastic material at the joint area between the transparent container body and the separate transparent bottom part.

21. Method according to claim 20, that the stationary laser means is sending a laser beam having a wavelength of 1900 to 2100 nm, preferably 2000 nm, which welds the transparent container body and the separate transparent bottom part without the use of absorber layers, whereas the melting heat is generated in the focus of the laser beam.
